(19) United States
(12) Patent Application Publication
(10) Pub. No.: US 2014/0218306 A1
(43) Pub. Date: Aug. 7, 2014

(54) METHOD FOR REMOTE CONTROL TO INPUT CHARACTERS TO DISPLAY DEVICE

(71) Applicant: SHENZHEN SKYWORTH-RGB ELECTRONICS CO. LTD., Shenzhen (CN)

(72) Inventors: Jia Liu, Ning An (CN); Xian-Hui Zeng, Shenzhen (CN); Rong Shen, Shenzhen (CN); Ming Chen, Shenzhen (CN)

(73) Assignee: SHENZHEN SKYWORTH-RGB ELECTRONICS CO. LTD., Shenzhen (CN)

(21) Appl. No.: 14/171,348

(22) Filed: Feb. 3, 2014

(30) Foreign Application Priority Data
Feb. 5, 2013 (CN) 201310043018.0

(51) Int. Cl. G06F 3/023; G06F 3/0489

(52) U.S. Cl. CPC G06F 3/0236; G06F 3/0489
USPC 345/169

(57) ABSTRACT

In one aspect of the invention, a method for a remote control to input characters to a display device includes: in response to a character input request sent by a remote control, displaying an input box and a soft keyboard, where the soft keyboard includes a plurality of preset characters arranged one by one; in response to a position movement instruction sent by an arrow button on the remote control, moving a cursor to a target character; and in response to an input confirmation instruction sent by an Ok button on the remote control, inputting the target character to the input box.

### CROSS-REFERENCE TO RELATED APPLICATION

This application claims the priority to Chinese Patent Application No. CN201310043018.0, filed on Feb. 5, 2013, in the State Intellectual Property Office of RR. China, which is hereby incorporated herein in its entirety by reference.

### FIELD OF THE INVENTION

The invention relates generally to the field of communications, and more particularly to a method for a remote control to input characters to a display device.

### BACKGROUND OF THE INVENTION

As content ends get rich and Internet technologies develop, how to use a remote control to rapidly input a character to a television is urgently desired.

As shown in FIGS. 1 and 2, in a conventional input method, numeric keys 1 to 9 on the remote control are multiplexed. For example, in order to input a Chinese character, e.g., “ [symbol] ”, the following steps need to be performed.

Step A: A television is set to enter an interface for inputting characters.

Step B: Press in sequence a “6” button, a “4” button, the “6” button and the “4” button on a remote control, so that the television shows an interface shown in FIG. 2.

Step C: Press a Down button among arrow buttons on the remote control to move a cursor to a Chinese character display area.

Step D: Press a Right button among the arrow buttons on the remote control to move the cursor to “ [symbol] ”.

Step E: Press an Ok button on the remote control to input the character “ [symbol] ” at the cursor into an input box.

The method for a remote control to input a character to a television in the prior art has the following shortcomings.

Character inputting involves many buttons, and the distances between the involved buttons are long, which makes functional buttons of the remote control complicated and reduction of the remote control in size very difficult. In addition, during character inputting, attention needs to be shifted between the remote control and the television constantly, which likely results in visual fatigue.

Therefore, a heretofore unaddressed need exists in the art to address the aforementioned deficiencies and inadequacies.

### SUMMARY OF THE INVENTION

One of the objectives of the invention is to provide a method for a remote control to input characters to a display device, so as to decrease the number of buttons involved in character inputting, thereby improving user experience.

In one aspect of the invention, a method for a remote control to input characters to a display device includes the following steps.

Step a: In response to a character input request sent by a remote control, display an input box and a soft keyboard, where the soft keyboard includes a plurality of preset characters arranged one by one.

Step b: In response to a position movement instruction sent by an arrow button on the remote control, move a cursor to a target character.

Step c: In response to an input confirmation instruction sent by an Ok button on the remote control, input the target character to the input box.

In one embodiment, Step a specifically includes the following steps.

Step a1: According to a received character input instruction, display an input box and a default soft keyboard.

Step a2: According to a received input method switch instruction, switch the default soft keyboard to a target soft keyboard.

The characters include pinyin characters, English characters, numeric characters, symbol characters, and five-stroke radical characters.

In one embodiment, Step a2 specifically includes the following steps.

Step a21: Receive an input method switch instruction sent by a Menu button on the remote control.

Step a22: According to the received input method switch instruction, switch the default soft keyboard to a target soft keyboard.

Alternatively, Step a2 specifically includes the following steps.

Step a23: In response to a position switch instruction sent by the Left and Right buttons on the remote control, move the cursor to the input box or the soft keyboard.

Step a24: When the cursor is in the input box, in response to an input method switch instruction sent by the Up button on the remote control, switch the default soft keyboard to the target soft keyboard.

In one embodiment, when the target soft keyboard displays a plurality of preset pinyin or English characters that are arranged one by one, Step b specifically includes the following steps.

Step b1: In response to a letter selection instruction sent by an arrow button of the remote control, move the cursor to a target letter.

Step b2: According to a preset character input mapping table, display a candidate Chinese or English character table corresponding to the target letter or a combination of the target letters.

Step b3: Receive the instruction from the remote control, and determine the type of the received instruction; when the received instruction from the remote control is a Chinese or English selection instruction sent by an arrow button of the remote control, perform Step b4; when the received instruction from the remote control is a letter input confirmation instruction sent by the Ok button of the remote control, perform Step b5; when the received instruction from the remote control is a return instruction sent by an arrow button of the remote control, perform Step b6.

Step b4: Move the cursor to a target Chinese or English character, and perform Step c.

Step b5: Input the target letter to a pre-selection box, and perform Step b1.

Step b6: Return to a state of the previous step.

In one embodiment, after Step b5 and before performing Step b1, the following steps are further included.

Step b7: According to the target letter input into the pre-selection box, rearrange letter characters on the soft keyboard according to an association function rule.

In one embodiment, when the target soft keyboard displays a plurality of preset pinyin characters that are arranged one by one, and after re-performing Step b1, the following steps are further included.

Step b8: Determine whether the target letter at the current cursor and the letter character input earlier into the pre-selection box can form a pinyin; if yes, perform Step b2; otherwise, perform Step b9.

Step b9: According to a preset phrase input mapping table, display a candidate Chinese phrase table corresponding to a phrase formed by the target letter at the current cursor and the letter character input earlier into the pre-selection box, and perform Step b3.

In one embodiment, the input box is multiplexed to be the pre-selection box.

In one embodiment, the method for a remote control to input characters to a display device further includes the following steps.

Step d1: In response to a position switch instruction sent by the Left and Right buttons on the remote control, switch the cursor to the input box or the soft keyboard.

Step d2: When the cursor is in the input box, in response to a delete character instruction sent by the Down button on the remote control, delete a character already input into the input box.

In one embodiment, the characters are pinyin characters, English characters, numeric characters, symbol characters, or five-stroke radical characters. Alternatively, the characters include letter characters, numeric characters, and symbol characters.

In one embodiment, the remote control is a shuttle remote control.

In one embodiment, the plurality of characters surrounds the input box and is evenly distributed. Alternatively, the plurality of characters is vertically evenly arranged on one side of the input box. Alternatively, the plurality of characters is horizontally evenly arranged on upper and lower sides of the input box.

In another aspect, the invention relates to a remote control configured to perform the above-disclosed method for inputting characters to a display device.

In one embodiment, the remote control is a shuttle remote control.

In yet another aspect, the invention relates to a non-transitory computer-readable medium storing instructions which, when performed by one or more processors, cause a remote control to perform the above-disclosed method for inputting characters to a display device.

In the method for a remote control to input characters to a display device provided by the invention, in response to a character input request sent by a remote control, an input box and a soft keyboard are displayed. The soft keyboard includes a plurality of preset characters that are arranged one by one. In this case, character inputting may be performed through arrow buttons and an OK button on the remote control. When a position movement instruction sent by an arrow button on the remote control is received, a cursor moves until reaching a target character. When an input confirmation instruction sent by the Ok button on the remote control is received, the target character at the cursor is input to the input box, thereby completing the character inputting. According to the invention, the characters on the soft keyboard are arranged one by one, and thus character inputting only involves the arrow buttons and the OK button, and not only the distance between the required buttons is shortened, and a character inputting speed is improved, but also the number of buttons required by the character inputting is decreased, thereby achieving the objectives of simplifying the design of the remote control and decreasing the volume of the remote control. Meanwhile, shifting of attention between the remote control and a television set is avoided, so as to alleviate visual fatigue incurred by character inputting, and eliminate input errors, thereby greatly improving user experience.

These and other aspects of the invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a schematic view of a remote control suitable for a method for a remote control to input characters to a display device in the prior art.

FIG. 2 is a schematic view of a state of an input box and a soft keyboard in the method for a remote control to input characters to a display device in the prior art.

FIG. 3 is a schematic flow chart of a first embodiment of a method for a remote control to input characters to a display device according to the invention.

FIG. 4 is a schematic view of a remote control suitable for the method for a remote control to input characters to a display device shown in FIG. 3.

FIG. 5 is a schematic view of a first state of an input box and a soft keyboard in the method for a remote control to input characters to a display device shown in FIG. 3.

FIG. 6 is a schematic flow chart of Step a in the method for a remote control to input characters to a display device shown in FIG. 3.

FIG. 7 is a schematic flow chart of a first embodiment of Step a2 shown in FIG. 6.

FIG. 8 is a schematic flow chart of a second embodiment of Step a2 shown in FIG. 6.

FIG. 9 is a schematic view of a second state of an input box and a soft keyboard in the method for a remote control to input characters to a display device shown in FIG. 3.

FIG. 10 is a schematic view of a third state of an input box and a soft keyboard in the method for a remote control to input characters to a display device shown in FIG. 3.

FIG. 11 is a schematic view of a fourth state of an input box and a soft keyboard in the method for a remote control to input characters to a display device shown in FIG. 3.

FIG. 12 is a schematic flow chart of a first embodiment of Step b in the method for a remote control to input characters to a display device shown in FIG. 3.

FIG. 13 is a schematic flow chart of a second embodiment of Step b in the method for a remote control to input characters to a display device shown in FIG. 3.

FIG. 14 is a schematic view of a state of a soft keyboard after a letter “b” is input into an input box in a method for a remote control to input characters to a display device according to the invention.

FIG. 15 is a schematic flow chart of a third embodiment of Step b in the method for a remote control to input characters to a display device shown in FIG. 3.

FIG. 16 is a schematic view of a state of a soft keyboard after a letter “b” is input into an input box and a cursor moves to “t” in a method for a remote control to input characters to a display device according to the invention.

FIG. 17 is a schematic flow chart of a second embodiment of the method for a remote control to input characters to a display device according to the invention.

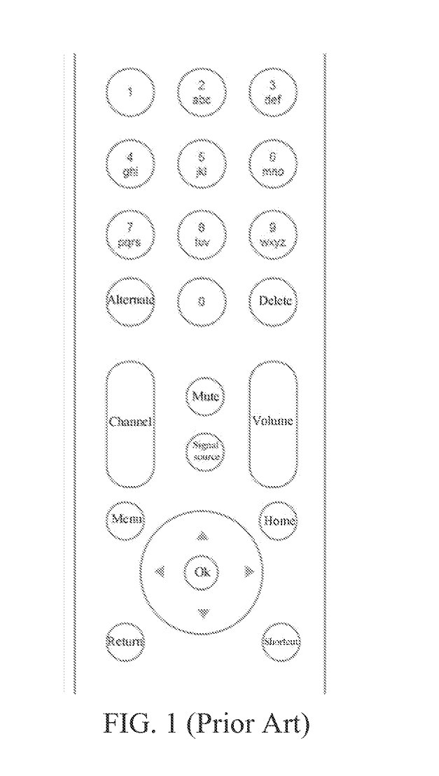

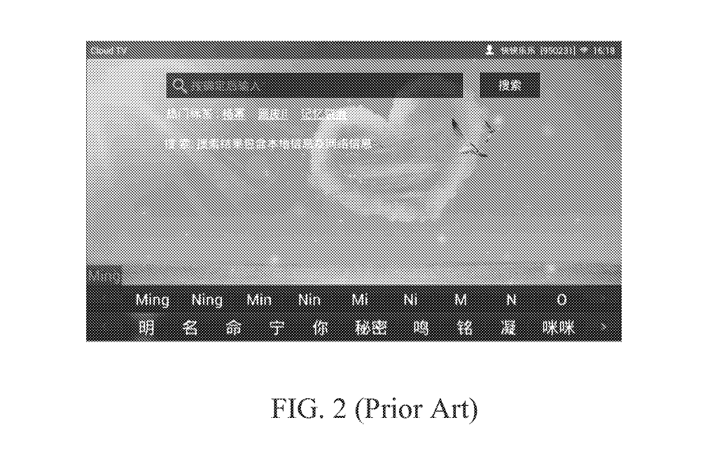

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are configured to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, although the terms first, second, third etc. may be used herein to describe various elements, components, regions, layers and/or sections, these elements, components, regions, layers and/or sections should not be limited by these terms. These terms are only configured to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be performed in different order (or concurrently) without altering the principles of the invention.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code performed by the processor.

The term “code”, as used herein, may include software, firmware, and/or microcode, and may refer to programs, routines, functions, classes, and/or objects. The term “shared”, as used herein, means that some or all code from multiple modules may be performed using a single (shared) processor. In addition, some or all code from multiple modules may be stored by a single (shared) memory. The term “group”, as used herein, means that some or all code from a single module may be performed using a group of processors. In addition, some or all code from a single module may be stored using a group of memories.

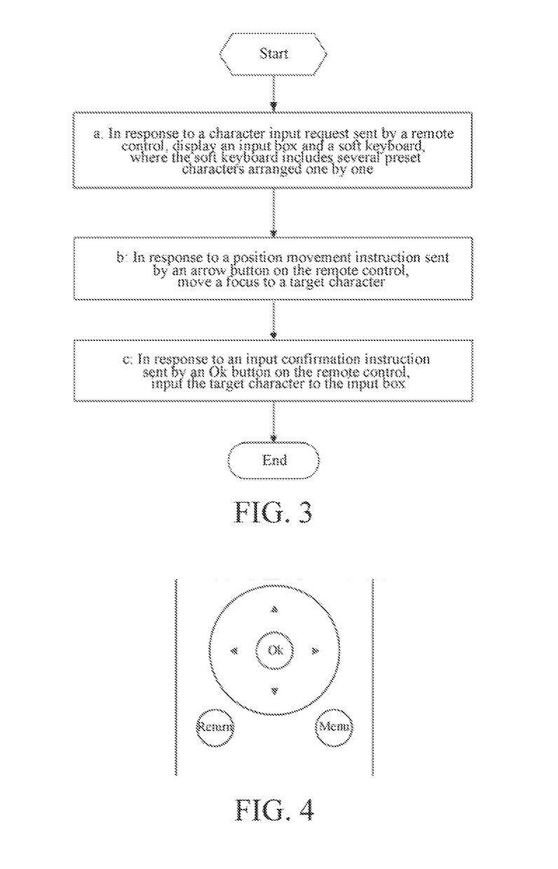

The description will be made as to the embodiments of the invention in conjunction with the accompanying drawings in FIGS. 3-17. It should be understood that specific embodiments described herein are merely used for explaining the invention, but are not intended to limit the invention. In accordance with the purposes of this disclosure, as embodied and broadly described herein, this invention, in one aspect, relates to a method for a remote control to input characters to a display device.

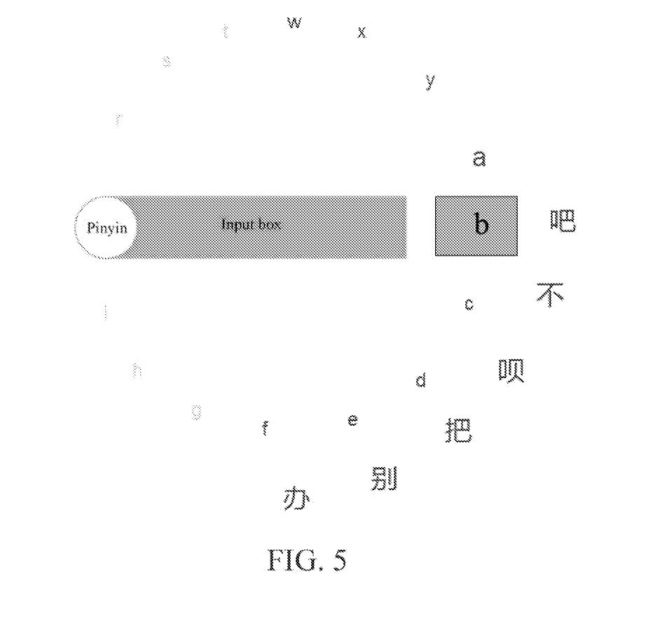

In one embodiment, a method for a remote control to input characters to a display device is shown in FIGS. 3-5. FIG. 3 is a schematic flow chart of a first embodiment of the method for a remote control to input characters to a display device according to the invention. FIG. 4 is a schematic view of a remote control suitable for the method for a remote control to input characters to a display device shown in FIG. 3. FIG. 5 is a schematic view of a first state of an input box and a soft keyboard in the method for a remote control to input characters to a display device shown in FIG. 3. In this embodiment, the method for a remote control to input characters to a display device includes the following steps.

Step a: In response to a character input request sent by a remote control, display an input box and a soft keyboard, where the soft keyboard includes a plurality of preset characters arranged one by one.

When a character needs to be input to a display device through the remote control, the remote control sends the character input request, and upon receiving the character input request, the display device displays the input box and the soft keyboard. The soft keyboard may be designed into multiple kinds according to input modes. The input modes may include a pinyin input method, an English input mode, a five-stroke input mode, a stroke input mode, a digit input mode, an expression input mode, and a symbol input mode. For example, when the input mode is the pinyin input mode, the soft keyboard includes 26 letter characters arranged one by one. For another example, when the input mode is the digit input mode, the soft keyboard includes ten numeric characters, 0-9, arranged one by one.

Step b: In response to a position movement instruction sent by an arrow button on the remote control, move a cursor to a target character.

The cursor on the display device may move according to the position movement instruction that is sent after the arrow button on the remote control is triggered. For example, after Left and Right buttons among the arrow buttons on the remote control are triggered, a position movement instruction is sent, so as to make the cursor move between the input box and the soft keyboard. For another example, when the cursor is located in the soft keyboard, after Up and Down buttons among the arrow buttons on the remote control are triggered, a position movement instruction is sent, so as to make the cursor move between several characters in the soft keyboard.

Step c: In response to an input confirmation instruction sent by an Ok button on the remote control, input the target character to the input box.

When the cursor is on a certain character, the Ok button on the remote control can make the character at the cursor be input into the input box.

In the method for a remote control to input characters to a display device provided by the invention, in response to the character input request sent by the remote control, the input box and the soft keyboard are displayed. The soft keyboard includes a plurality of preset characters that are arranged one by one. In this case, character inputting may be performed through the arrow buttons and the OK button on the remote control. When the position movement instruction sent by the arrow button on the remote control is received, the cursor moves until reaching the target character. When the input confirmation instruction sent by the Ok button on the remote control is received, the target character at the cursor is input to the input box, thereby completing the character inputting. According to the invention, the characters on the soft keyboard are arranged one by one, and thus character inputting only involves the arrow buttons and the OK button, and not only the distance between the required buttons is shortened, and a character inputting speed is improved, but also the number of buttons required by the character inputting is decreased, thereby achieving the objectives of simplifying the design of the remote control and decreasing the volume of the remote control. Meanwhile, shifting of attention between the remote control and the television set is avoided, so as to alleviate visual fatigue incurred by character inputting, and eliminate input errors, thereby greatly improving user experience.

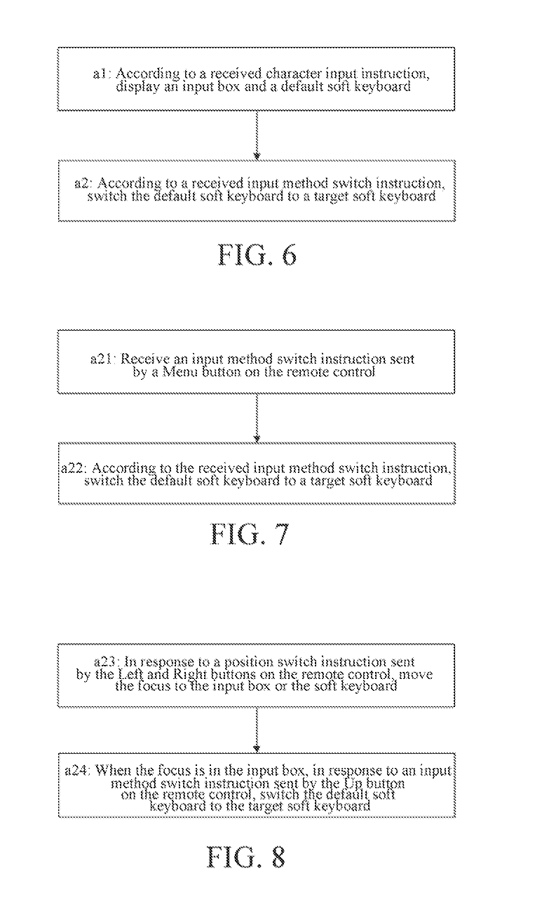

The input modes may include the pinyin input mode, the English input mode, the five-stroke input mode, the stroke input mode, the digit input mode, the expression input mode, and the symbol input mode, and a user can select any input mode according to needs. That is to say, when the soft keyboard includes pinyin characters, English characters, numeric characters, symbol characters, and five-stroke radical characters that are preset and arranged one by one, the soft keyboard needs to switch between the pinyin characters, the English characters, the numeric characters, the symbol characters, and the five-stroke radical characters. Referring to FIG. 6, which is a schematic flow chart of Step a in the method for a remote control to input characters to a display device shown in FIG. 3, in a specific embodiment, Step a in the method for a remote control to input characters to a display device shown in FIG. 3 includes the following specific steps.

Step a1: According to a received character input instruction, display an input box and a default soft keyboard.

Step a2: According to a received input method switch instruction, switch the default soft keyboard to a target soft keyboard.

The default soft keyboard may include pinyin characters, or English characters, or numeric characters, or symbol characters, or five-stroke radical characters, which are preset and arranged one by one. For example, the default soft keyboard is the soft keyboard corresponding to the pinyin input mode, that is, the soft keyboard displays 26 letter characters that are arranged one by one. In order to input a digit, a user sends an input method switch instruction through the remote control, and the display device, in response to the input method switch instruction, switches the current soft keyboard corresponding to the pinyin input mode to the soft keyboard corresponding to the digit input mode, that is, switches the 26 letter characters that are arranged one by one to 10 numeric characters, 0-9, that are arranged one by one.

Definitely the input modes in the method for a remote control to input characters to a display device according to the invention are not limited to the aforementioned manner. For example, only one input mode may exist, that is, no input method switch operation needs to be performed, and in this case, the soft keyboard includes pinyin characters, English characters, numeric characters, symbol characters, or five-stroke radical characters, which are preset and arranged one by one. In other embodiment variations, alternatively, the soft keyboard may include a combination of letter characters, numeric characters, and symbol characters, that are preset and arranged one by one, and in this case no input method switch operation needs to be performed either.

FIG. 7 is a schematic flow chart of a first embodiment of Step a2 shown in FIG. 6. In the specific embodiment, Step a2 shown in FIG. 6 includes the following specific steps.

Step a21: Receive an input method switch instruction sent by a Menu button on the remote control.

Step a22: According to the received input method switch instruction, switch the default soft keyboard to a target soft keyboard.

In order to conveniently and rapidly switch the input method, the remote control is provided with a shortcut button for switching the input method. Definitely, the exiting Menu button on the remote control may be multiplexed for switching the input method.

FIG. 8 is a schematic flow chart of a second embodiment of Step a2 shown in FIG. 6. In the specific embodiment, Step a2 shown in FIG. 6 includes the following specific steps.

Step a23: In response to a position switch instruction sent by the Left and Right buttons on the remote control, move the cursor to the input box or the soft keyboard.

Step a24: When the cursor is in the input box, in response to an input method switch instruction sent by the Up button on the remote control, switch the default soft keyboard to the target soft keyboard.

In this embodiment, during the input method switch operation, the cursor needs to be moved to the input box before the input method switch operation can be performed. It should be understood that, the remote control sending the position switch instruction is not limited to be triggered by the Left and Right buttons, and the remote control sending the input method switch instruction is not limited to be triggered by the Up button either, which may be designed according to use habits and intuitiveness.

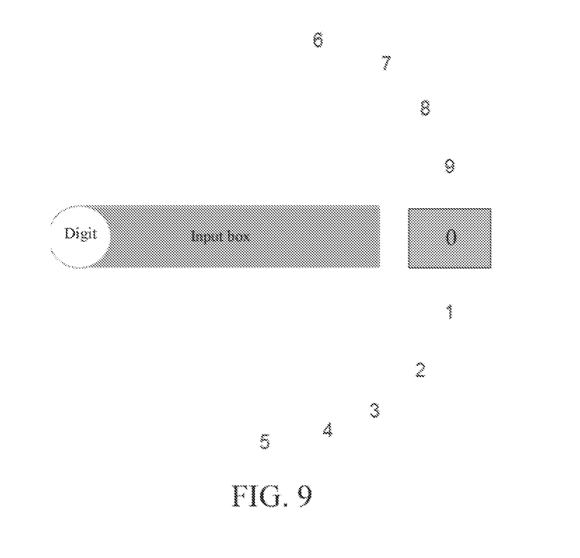

When a numeric character needs to be input, the soft keyboard displays 10 numeric characters, 0-9, which are arranged one by one. The soft keyboard in this case may be referred to FIG. 9, which is a schematic view of a second state of the input box and the soft keyboard in the method for a remote control to input characters to a display device shown in FIG. 3. Operations performed to input a character “3” are taken as an example below to describe the embodiment of the invention.

1. The remote control sends a character input request. The display device displays an input box and a soft keyboard. In this case, the soft keyboard is as what is shown in FIG. 9.

When the current soft keyboard is not for numeric characters, an input method switch operation needs to be performed.

2. The Right button of the remote control is pressed to send a position switch instruction, and the cursor is switched from the input box to a numeric area in the soft keyboard.

When the cursor is located in the numeric area of the soft keyboard, Step 2 is skipped.

3. The Down button of the remote control is pressed to send a position movement instruction, and the cursor moves from the digit “0” to the digit “3”.

4. The Ok button on the remote control is pressed to send an input confirmation instruction, and the digit “3” is input into the input box.

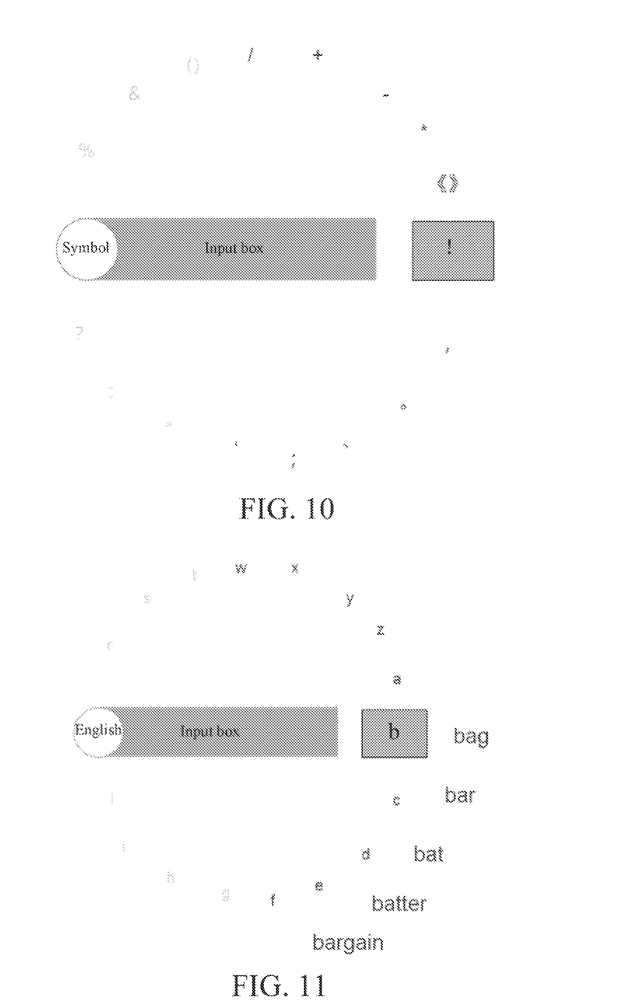

When a symbol character needs to be input, the soft keyboard displays a plurality of symbol characters arranged one by one. The soft keyboard in this case may be referred to FIG. 10, which is a schematic view of a third state of the input box and the soft keyboard in the method for a remote control to input characters to a display device shown in FIG. 3. Steps for inputting a symbol are the same as the steps for digit inputting, and may be referred to the description of digit inputting, which is not repeated herein.

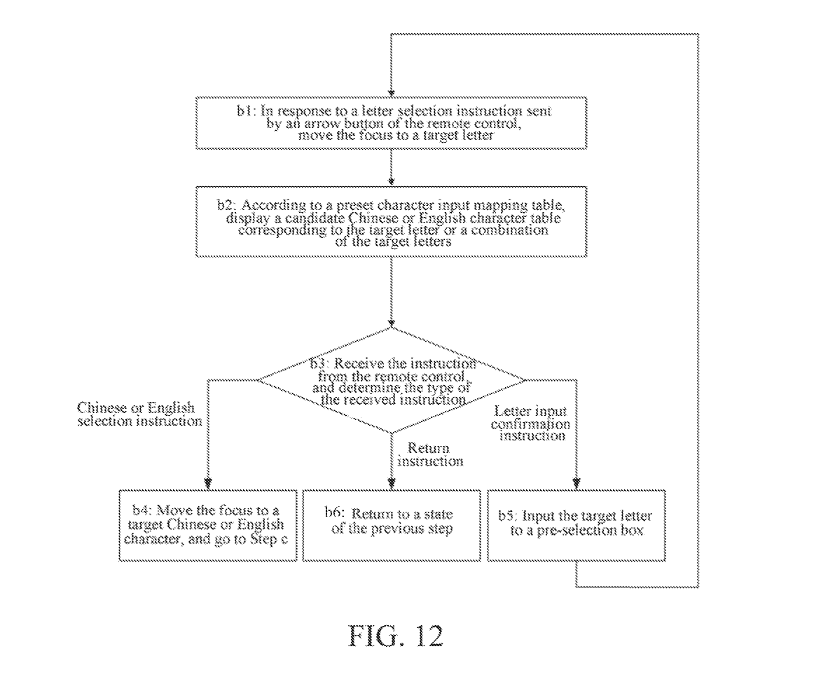

When a Chinese character needs to be input, the soft keyboard displays 26 pinyin characters arranged one by one, and the soft keyboard in this case may be referred to FIG. 5 again. When an English character needs to be input, the soft keyboard displays 26 English characters that are arranged one by one. The soft keyboard in this case may be referred to FIG. 11, which is a schematic view of a fourth state of the input box and the soft keyboard in the method for a remote control to input characters to a display device shown in FIG. 3. Also referring to FIG. 12, which is a schematic flow chart of a first embodiment of Step b in the method for a remote control to input characters to a display device shown in FIG. 3, in this embodiment, Step b in the method for a remote control to input characters to a display device shown in FIG. 3 includes the following specific steps.

Step b1: In response to a letter selection instruction sent by an arrow button of the remote control, move the cursor to a target letter.

Step b2: According to a preset character input mapping table, display a candidate Chinese or English character table corresponding to the target letter or a combination of the target letters.

Step b3: Receive the instruction from the remote control, and determine the type of the received instruction; when the received instruction from the remote control is a Chinese or English selection instruction sent by an arrow button of the remote control, perform Step b4; when the received instruction from the remote control is a letter input confirmation instruction sent by the Ok button of the remote control, perform Step b5; when the received instruction from the remote control is a return instruction sent by an arrow button of the remote control, perform Step b6.

Step b4: Move the cursor to a target Chinese or English character, and perform Step c.

Step b5: Input the target letter to a pre-selection box, and perform Step b1.

Step b6: Return to a state of the previous step.

Operations performed to input a character “ [symbol] ” are taken as an example below to describe the embodiment of the invention.

1. The remote control sends a character input request. The display device displays an input box and a soft keyboard.

When the current soft keyboard is not for pinyin characters, an input method switch operation needs to be performed.

2. The Right button of the remote control is pressed to send a position switch instruction, and the cursor is switched from the input box to the letter area in the soft keyboard.

When the cursor is located in the letter area of the soft keyboard, Step 2 is skipped. When the cursor is located in the Chinese character area of the soft keyboard, in Step 2, the Left button of the remote control is pressed to send a position movement instruction to move the cursor to the letter area.

3. The Down button of the remote control is pressed to send a position movement instruction. The cursor moves from the letter “a” to the letter “b”. According to a preset character input mapping table, a candidate Chinese character table corresponding to “b” is displayed, and for example, [symbol] etcetera are displayed. In this case, the soft keyboard is as what is shown in FIG. 5.

4. Since the character “ [symbol] ” is in the candidate Chinese character table, the Right button of the remote control is pressed to send a position movement instruction, and the cursor moves from the letter area to the Chinese character area.

5. The Down button of the remote control is pressed (it is not limited to one pressing) to send a position movement instruction, and the cursor moves to the Chinese character “ [symbol] ”.

6. The Ok button on the remote control is pressed to send an input confirmation instruction, and the Chinese character “ [symbol] ” is input into the input box.

Operations performed to input a character “ [symbol] ” are taken as an example below to describe the embodiment of the invention.

1. The remote control sends a character input request. The display device displays an input box and a soft keyboard.

When the current soft keyboard is not for pinyin characters, an input method switch operation needs to be performed.

2. The Right button of the remote control is pressed to send a position switch instruction, and the cursor is switched from the input box to the letter area in the soft keyboard.

When the cursor is located in the letter area of the soft keyboard, Step 2 is skipped. When the cursor is located in the Chinese character area of the soft keyboard, in Step 2, the Left button of the remote control is pressed to send a position movement instruction to move the cursor to the letter area.

3. The Down button of the remote control is pressed to send a position movement instruction. The cursor moves from the letter “a” to the letter “b”. According to a preset character input mapping table, a candidate Chinese character table corresponding to “b” is displayed, and for example, [symbol] etcetera are displayed. In this case, the soft keyboard is as what is shown in FIG. 5.

4. The character “ [symbol] ” is not in the candidate Chinese character table, so that in this case, the Ok button of the remote control is pressed to send a letter input confirmation instruction, and the letter “b” is input into the pre-selection box.

If the cursor is away from the letter character to be selected, in response to the pressed Left button of the remote control, the cursor may be switched to the input box, and further in response to the pressed Right button of the remote control, the cursor may be switched to a letter character area.

5. The Up button of the remote control is pressed to send a position movement instruction. The cursor moves from the letter “b” to the letter “a”. According to a preset character input mapping table, a candidate Chinese character table corresponding to “ba” is displayed, and for example, [symbol] etcetera are displayed.

6. Since the character “ [symbol] ” is in the candidate Chinese character table, the Right button of the remote control is pressed to send a position movement instruction, and the cursor moves from the letter area to the Chinese character area.

7. The Down button of the remote control is pressed (it is not limited to one pressing) to send a position movement instruction, and the cursor moves to the Chinese character “ [symbol] ”.

8. The Ok button on the remote control is pressed to send an input confirmation instruction, and the Chinese character “ [symbol] ” is input into the input box.

Operations performed to input characters “bag” are taken as an example below to describe the embodiment of the invention.

1. The remote control sends a character input request. The display device displays an input box and a soft keyboard.

When the current soft keyboard is not for pinyin characters, an input method switch operation needs to be performed.

2. The Right button of the remote control is pressed to send a position switch instruction, and the cursor is switched from the input box to a letter area in the soft keyboard.

When the cursor is located in the letter area of the soft keyboard, Step 2 is skipped. When the cursor is located in the Chinese character area of the soft keyboard, in Step 2, the Left button of the remote control is pressed to send a position movement instruction to move the cursor to the letter area.

3. The Down button of the remote control is pressed to send a position movement instruction. The cursor moves from the letter “a” to the letter “b”. According to a preset character input mapping table, a candidate English character table corresponding to “b” is displayed, and for example, bag, bar, bat, batter, bargain, etcetera are displayed. In this case, the soft keyboard is as what is shown in FIG. 11.

4. Since the characters “bag” are in the candidate English character table, the Right button of the remote control is pressed to send a position movement instruction, and the cursor moves from the letter area to the English character area.

The cursor falls just on the English characters “bag”, so that the Down button of the remote control does not need to be used to send a position movement instruction, and Step 5 may be directly performed.

5. The Ok button on the remote control is pressed to send an input confirmation instruction, and the English characters “bag” are input into the input box.

When a five-stroke radical character needs to be input, the soft keyboard displays a plurality of five-stroke radical characters arranged one by one. Steps for inputting a five-stroke radical are the same as the steps for pinyin inputting, and may be referred to the description of pinyin inputting, which is not repeated herein.

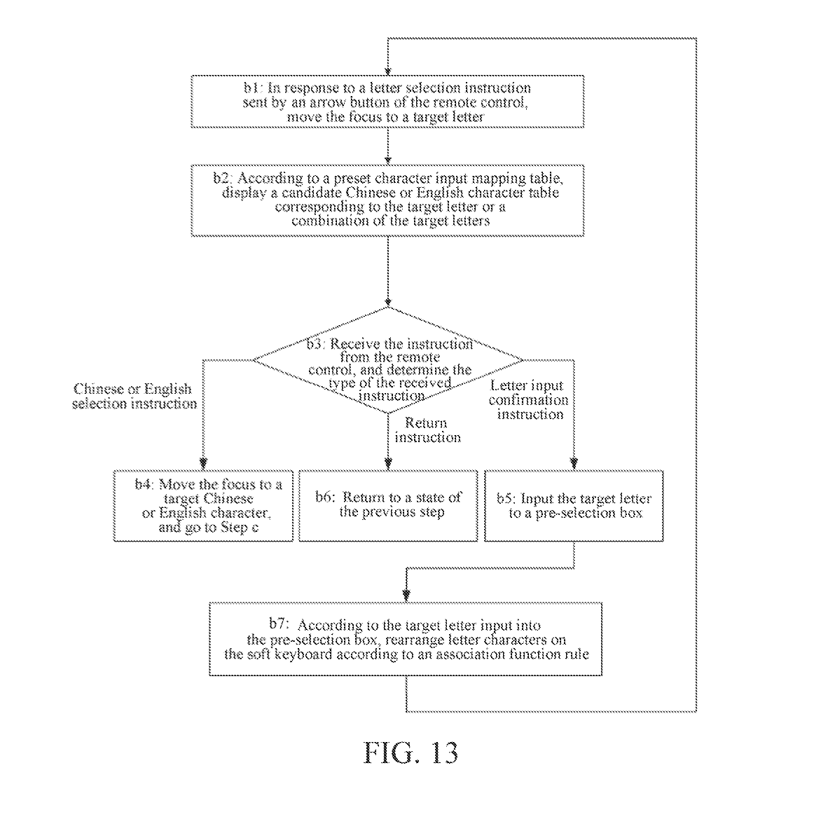

In order to increase the character input speed, the method for a remote control to input characters to a display device according to the invention further has an association function. FIG. 13 is a schematic flow chart of a second embodiment of Step b in the method for a remote control to input characters to a display device shown in FIG. 3. On the basis of the embodiment shown by FIG. 12, this embodiment further includes Step b7, Step b7 is after Step b5 and before performing Step b1. In this embodiment, Step b in the method for a remote control to input characters to a display device shown in FIG. 3 includes the following specific steps.

Step b1: In response to a letter selection instruction sent by an arrow button of the remote control, move the cursor to a target letter.

Step b2: According to a preset character input mapping table, display a candidate Chinese or English character table corresponding to the target letter or a combination of the target letters.

Step b3: Receive the instruction from the remote control, and determine the type of the received instruction; when the received instruction from the remote control is a Chinese or English selection instruction sent by an arrow button of the remote control, perform Step b4; when the received instruction from the remote control is a letter input confirmation instruction sent by the Ok button of the remote control, perform Step b5; when the received instruction from the remote control is a return instruction sent by an arrow button of the remote control, perform Step b6.

Step b4: Move the cursor to a target Chinese or English character, and perform Step c.

b5: Input the target letter to a pre-selection box.

Step b7: According to the target letter input into the pre-selection box, rearrange letter characters on the soft keyboard according to an association function rule, and perform Step b1.

Step b6: Return to a state of the previous step.

Operations performed to input a character “ [symbol] ” are taken as an example below to describe the embodiment of the invention.

1. The remote control sends a character input request. The display device displays an input box and a soft keyboard.

When the current soft keyboard is not for pinyin characters, an input method switch operation needs to be performed.

2. The Right button of the remote control is pressed to send a position switch instruction, and the cursor is switched from the input box to a letter area in the soft keyboard.

When the cursor is located in the letter area of the soft keyboard, Step 2 is skipped. When the cursor is located in the Chinese character area of the soft keyboard, in Step 2, the Left button of the remote control is pressed to send a position movement instruction to move the cursor to the letter area.

3. The Up and Down buttons of the remote control are pressed to send a position movement instruction. The cursor moves from the letter “a” to the letter “b”. According to a preset character input mapping table, a candidate Chinese character table corresponding to “b” is displayed, and for example, [symbol] etcetera are displayed. In this case, the soft keyboard is as what is shown in FIG. 5.

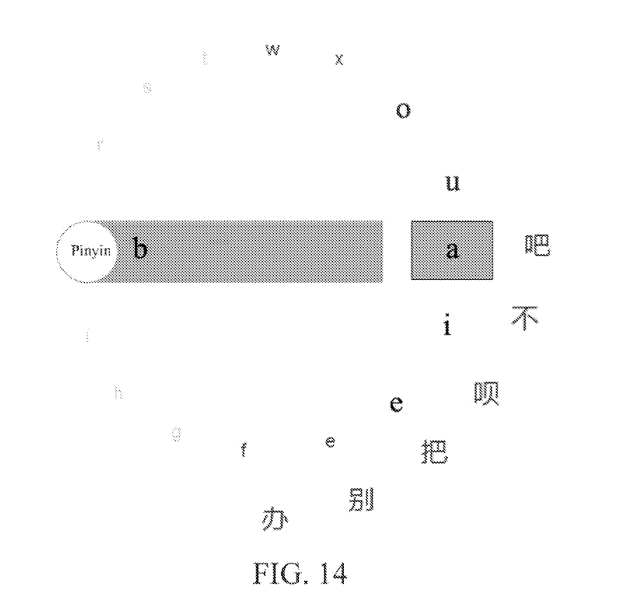

4. The character “ [symbol] ” is not in the candidate Chinese character table, so that in this case, the Ok button of the remote control is pressed to send a letter input confirmation instruction, the letter “b” is input into the pre-selection box, and letter characters are rearranged according to an association function rule, as shown in FIG. 14, FIG. 14 being a schematic view of a state of the soft keyboard after the letter “b” is input into the input box in the method for a remote control to input characters to a display device according to the invention.

If the cursor is away from the letter character to be selected, in response to the pressed Left button of the remote control, the cursor may be switched to the input box, and further in response to the pressed Right button of the remote control, the cursor may be switched to a letter character area.

5. According to a preset character input mapping table, a candidate Chinese character table corresponding to “ba” is displayed, and for example, [symbol] [symbol] , etcetera are displayed.

6. Since the character “ [symbol] ” is in the candidate Chinese character table, the Right button of the remote control is pressed to send a position movement instruction, and the cursor moves from the letter area to the Chinese character area.

7. The Down button of the remote control is pressed (it is not limited to one pressing) to send a position movement instruction, and the cursor moves to the Chinese character “ [symbol] ”.

8. The Ok button on the remote control is pressed to send an input confirmation instruction, and the Chinese character “ [symbol] ” is input into the input box.

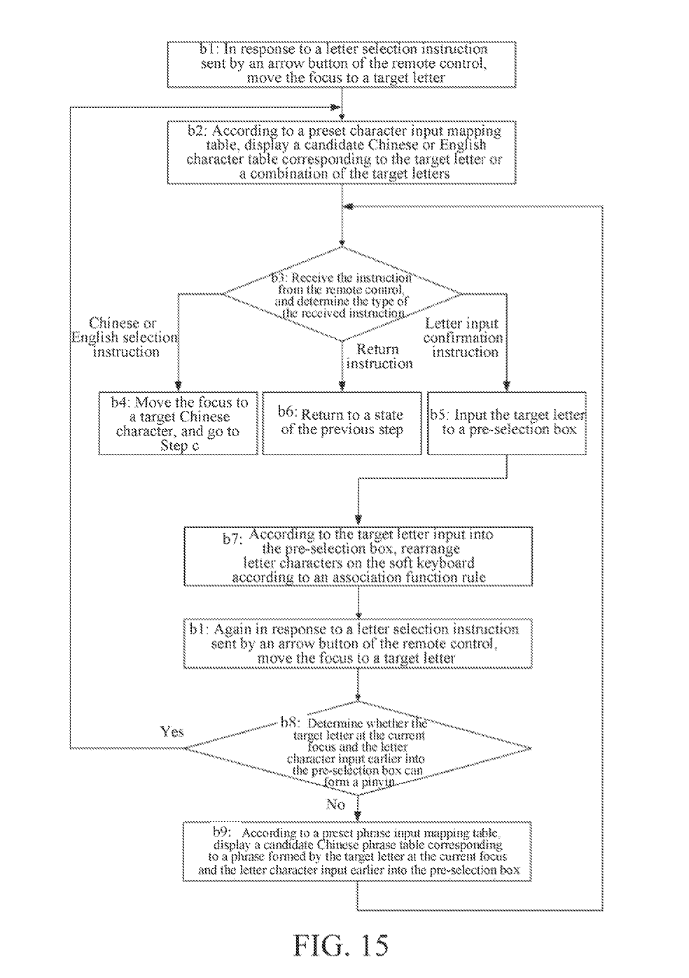

In order to increase input speed, during Chinese character inputting, a phrase may be input. If “ [symbol] ” needs to be input, the letter characters “b” and “t” may be selected successively, and during association, phrases such as “ [symbol] ” may be displayed. Referring to FIG. 15, FIG. 15 is a schematic flow chart of a third embodiment of Step b in the method for a remote control to input characters to a display device shown in FIG. 3. On the basis of the embodiment shown by FIG. 13, this embodiment further includes Step b8 and Step b9, and Step b8 is after re-performing Step b1. In this embodiment, Step b in the method for a remote control to input characters to a display device shown in FIG. 3 includes the following specific steps.

Step b1: In response to a letter selection instruction sent by an arrow button of the remote control, move the cursor to a target letter.

Step b2: According to a preset character input mapping table, display a candidate Chinese or English character table corresponding to the target letter or a combination of the target letters.

Step b3: Receive the instruction from the remote control, and determine the type of the received instruction; when the received instruction from the remote control is a Chinese or English selection instruction sent by an arrow button of the remote control, perform Step b4; when the received instruction from the remote control is a letter input confirmation instruction sent by the Ok button of the remote control, perform Step b5; when the received instruction from the remote control is a return instruction sent by an arrow button of the remote control, perform Step b6.

Step b4: Move the cursor to a target Chinese or English character, and perform Step c.

Step b5: Input the target letter to a pre-selection box.

Step b7: According to the target letter input into the pre-selection box, rearrange letter characters on the soft keyboard according to an association function rule.

Step b1: Again in response to a letter selection instruction sent by an arrow button of the remote control, move the cursor to a target letter.

Step b8: Determine whether the target letter at the current cursor and the letter character input earlier into the pre-selection box can form a pinyin; if yes, perform Step b2; otherwise, perform Step b9.

Step b9: According to a preset phrase input mapping table, display a candidate Chinese phrase table corresponding to a phrase formed by the target letter at the current cursor and the letter character input earlier into the pre-selection box, and perform Step b3.

Step b6: Return to a state of the previous step.

Operations performed to input characters “ [symbol] ” are taken as an example below to describe the embodiment of the invention.

1. The remote control sends a character input request. The display device displays an input box and a soft keyboard.

When the current soft keyboard is not for pinyin characters, an input method switch operation needs to be performed.

2. The Right button of the remote control is pressed to send a position switch instruction, and the cursor is switched from the input box to a letter area in the soft keyboard.

When the cursor is located in the letter area of the soft keyboard, Step 2 is skipped. When the cursor is located in the Chinese character area of the soft keyboard, in Step 2, the Left button of the remote control is pressed to send a position movement instruction to move the cursor to the letter area.

3. The Down button of the remote control is pressed to send a position movement instruction. The cursor moves from the letter “a” to the letter “b”. According to a preset character input mapping table, a candidate Chinese character table corresponding to “b” is displayed, and for example, [symbol] etcetera are displayed. In this case, the soft keyboard is as what is shown in FIG. 5.

4. The character “ [symbol] ” is not in the candidate Chinese character table, so that in this case, the Ok button of the remote control is pressed to send a letter input confirmation instruction, the letter “b” is input into the pre-selection box, and letter characters are rearranged according to an association function rule, as shown in FIG. 14, FIG. 14 being a schematic view of a state of the soft keyboard after the letter “b” is input into the input box in the method for a remote control to input characters to a display device according to the invention.

If the cursor is away from the letter character to be selected, in response to the pressed Left button of the remote control, the cursor may be switched to the input box, and further in response to the pressed Right button of the remote control, the cursor may be switched to a letter character area.

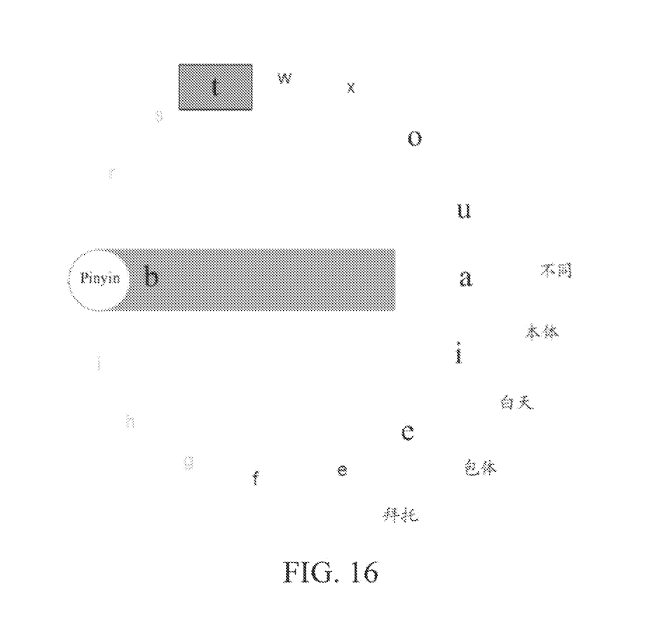

5. The Up button of the remote control is pressed to send a position movement instruction. The cursor moves from the letter “b” to the letter “t”. According to a preset character input mapping table, a candidate Chinese phrase table corresponding to “b” and “t” is displayed, and for example, [symbol] [symbol] etcetera are displayed. Referring to FIG. 16, FIG. 16 is a schematic view of a state of the soft keyboard after the letter “b” is input into the input box and the cursor moves to “t” in the method for a remote control to input characters to a display device according to the invention.

6. Since the characters “ [symbol] ” are in the candidate Chinese phrase table, the Right button of the remote control is pressed to send a position movement instruction, and the cursor moves from the letter area to the Chinese character area.

7. The Down button of the remote control is pressed (it is not limited to one pressing) to send a position movement instruction, and the cursor moves to the phrase “ [symbol] [symbol] ”.

8. The Ok button on the remote control is pressed to send an input confirmation instruction, and the phrase “ [symbol] ” is input into the input box.

In a specific embodiment, the pre-selection box is located in the soft keyboard, and flush with the input box. In a preferred embodiment, the input box may be multiplexed to be the pre-selection box, so as to simplify the design of the soft keyboard.

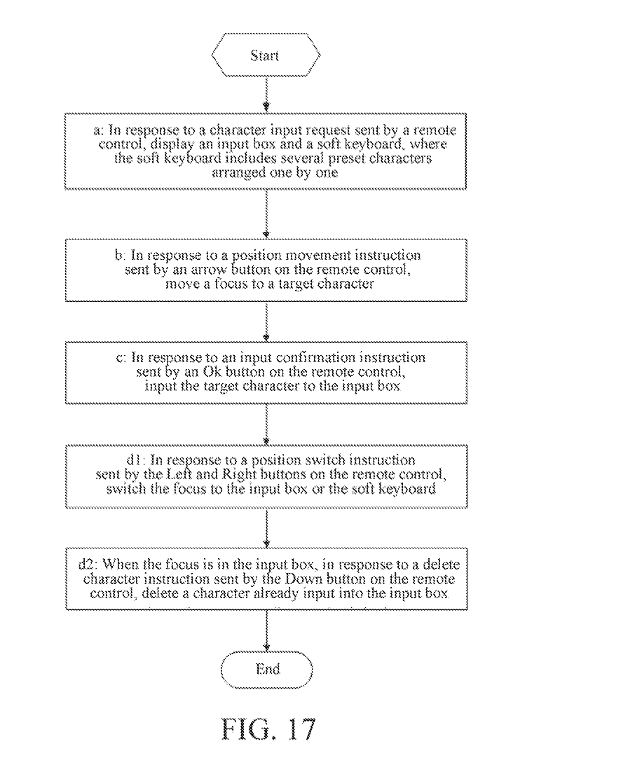

Referring to FIG. 17, FIG. 17 is a schematic flow chart of a second embodiment of the method for a remote control to input characters to a display device according to the invention. On the basis of the embodiment shown by FIG. 3, this embodiment further includes Step d1 and Step d2. In this embodiment, the method for a remote control to input characters to a display device according to the invention includes the following steps.

Step a: In response to a character input request sent by a remote control, display an input box and a soft keyboard, where the soft keyboard includes a plurality of preset characters arranged one by one.

Step b: In response to a position movement instruction sent by an arrow button on the remote control, move a cursor to a target character.

Step c: In response to an input confirmation instruction sent by an Ok button on the remote control, input the target character to the input box.

Step d1: In response to a position switch instruction sent by the Left and Right buttons on the remote control, switch the cursor to the input box or the soft keyboard.

Step d2: When the cursor is in the input box, in response to a delete character instruction sent by the Down button on the remote control, delete a character already input into the input box.

In this embodiment, during the character delete operation, the cursor needs to be switched to the input box before the character delete operation can be performed. It should be understood that, the remote control sending the position switch instruction is not limited to be triggered by the Left and Right buttons, and the remote control sending the delete character instruction is not limited to be triggered by the Down button either, which may be designed according to use habits and intuitiveness.

In a preferred embodiment, the remote control of the invention is a shuttle remote control, and in this case the character selection speed is higher, so as to further increase the character input speed.

In one embodiment, arrangement of characters in the soft keyboard may be designed according to needs. In one embodiment, a plurality of characters in the soft keyboard surround the input box and are evenly distributed. Alternatively, a plurality of characters in the soft keyboard is vertically evenly arranged on one side of the input box. Alternatively, a plurality of characters in the soft keyboard is horizontally evenly arranged on upper and lower sides of the input box.

In one aspect, the invention relates to a remote control configured to perform the above-disclosed method for inputting characters to a display device. In one embodiment, the remote control is a shuttle remote control.

It should be noted that all or a part of the steps according to the embodiments of the invention is implemented by hardware or a program instructing relevant hardware. Yet another aspect of the invention provides a non-transitory computer readable storage medium which stores computer performable instructions or program codes which, when performed by one or more processors, cause a remote control to perform the above-disclosed method for inputting characters to a display device. The computer performable instructions or program codes enable one or more processors to complete various operations in the above disclosed method. The storage medium includes, but not limited to, a magnetic disk, an optical disk, a read-only memory (ROM), a random access memory (RAM), random memory (RAM), flash dive, or the likes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A method for a remote control to input characters to a display device, comprising:
(a) in response to a character input request sent by a remote control, displaying an input box and a soft keyboard, wherein the soft keyboard comprises a plurality of preset characters arranged one by one;
(b) in response to a position movement instruction sent by an arrow button on the remote control, moving a cursor to a target character; and
(c) in response to an input confirmation instruction sent by an Ok button on the remote control, inputting the target character to the input box,
wherein the characters comprise pinyin characters, English characters, numeric characters, symbol characters, and five-stroke radical characters.

2. The method according to claim 1, wherein Step (a) comprises:
(a1) according to a received character input instruction, displaying the input box and a default soft keyboard; and
(a2) according to a received input method switch instruction, switching the default soft keyboard to a target soft keyboard.

3. The method according to claim 2, wherein Step (a2) comprises:
(a21) receiving the input method switch instruction sent by a Menu button on the remote control; and
(a22) according to the received input method switch instruction, switching the default soft keyboard to the target soft keyboard.

4. The method according to claim 2, wherein Step (a2) comprises:
(a23) in response to a position switch instruction sent by Left and Right buttons on the remote control, moving the cursor to the input box or the soft keyboard; and
(a24) when the cursor is in the input box, in response to an input method switch instruction sent by an Up button on the remote control, switching the default soft keyboard to the target soft keyboard.

5. The method according to claim 1, wherein when the target soft keyboard displays a plurality of preset pinyin or English characters that are arranged one by one, Step (b) comprises:
(b1) in response to a letter selection instruction sent by an arrow button of the remote control, moving the cursor to a target letter;
(b2) according to a preset character input mapping table, displaying a candidate Chinese or English character table corresponding to the target letter or a combination of the target letters;
(b3) receiving the instruction from the remote control, and determining the type of the received instruction; when the received instruction from the remote control is a Chinese or English selection instruction sent by an arrow button of the remote control, performing Step (b4); when the received instruction from the remote control is a letter input confirmation instruction sent by the Ok button of the remote control, performing Step (b5); when the received instruction from the remote control is a return instruction sent by an arrow button of the remote control, performing Step (b6);
(b4) moving the cursor to a target Chinese or English character, and performing Step (c);
(b5) inputting the target letter to a pre-selection box, and performing Step b1; and
(b6) returning to a state of the previous step.

6. The method according to claim 5, wherein after Step (b5) and before performing Step (b1), the method further comprises:
(b7) according to the target letter input into the pre-selection box, rearranging letter characters on the soft keyboard according to an association function rule.

7. The method according to claim 6, wherein when the target soft keyboard displays a plurality of preset pinyin characters that are arranged one by one, and after re-performing Step (b1), the method further comprises:
(b8) determining whether the target letter at the current cursor and the letter character input earlier into the pre-selection box are able to form a pinyin; if yes, performing Step (b2); otherwise, performing Step (b9); and
(b9) according to a preset phrase input mapping table, displaying a candidate Chinese phrase table corresponding to a phrase formed by the target letter at the current cursor and the letter character input earlier into the pre-selection box, and performing Step (b3).

8. The method according to claim 5, wherein the input box is multiplexed to be the pre-selection box.

9. The method according to claim 8, further comprising:
(d1) in response to a position switch instruction sent by the Left and Right buttons on the remote control, switching the cursor to the input box or the soft keyboard; and
(d2) when the cursor is in the input box, in response to a delete character instruction sent by the Down button on the remote control, deleting a character already input into the input box.

10. The method according to claim 1, wherein the characters are pinyin characters, English characters, numeric characters, symbol characters, or five-stroke radical characters; alternatively, the characters comprise letter characters, numeric characters, and symbol characters.

11. The method according to claim 1, wherein the plurality of characters surround the input box and are evenly distributed; alternatively, the plurality of characters are vertically evenly arranged on one side of the input box; alternatively, the plurality of characters are horizontally evenly arranged on upper and lower sides of the input box.

12. The method according to claim 1, wherein the remote control is a shuttle remote control.

13. A non-transitory computer-readable medium storing instructions which, when executed by one or more processors, cause a remote control to perform a method for inputting characters to a display device, wherein the method comprises:
(a) in response to a character input request sent by a remote control, displaying an input box and a soft keyboard, wherein the soft keyboard comprises a plurality of preset characters arranged one by one;
(b) in response to a position movement instruction sent by an arrow button on the remote control, moving a cursor to a target character; and
(c) in response to an input confirmation instruction sent by an Ok button on the remote control, inputting the target character to the input box,
wherein the characters comprise pinyin characters, English characters, numeric characters, symbol characters, and five-stroke radical characters.

14. The non-transitory computer-readable medium according to claim 13, wherein Step (a) comprises:
(a1) according to a received character input instruction, displaying the input box and a default soft keyboard; and
(a2) according to a received input method switch instruction, switching the default soft keyboard to a target soft keyboard.

15. The non-transitory computer-readable medium according to claim 14, wherein Step (a2) comprises:
(a21) receiving the input method switch instruction sent by a Menu button on the remote control; and
(a22) according to the received input method switch instruction, switching the default soft keyboard to the target soft keyboard.

16. The non-transitory computer-readable medium according to claim 14, wherein Step (a2) comprises:
(a23) in response to a position switch instruction sent by Left and Right buttons on the remote control, moving the cursor to the input box or the soft keyboard; and
(a24) when the cursor is in the input box, in response to an input method switch instruction sent by an Up button on the remote control, switching the default soft keyboard to the target soft keyboard.

17. The non-transitory computer-readable medium according to claim 13, wherein when the target soft keyboard displays a plurality of preset pinyin or English characters that are arranged one by one, Step (b) comprises:
(b1) in response to a letter selection instruction sent by an arrow button of the remote control, moving the cursor to a target letter;
(b2) according to a preset character input mapping table, displaying a candidate Chinese or English character table corresponding to the target letter or a combination of the target letters;
(b3) receiving the instruction from the remote control, and determining the type of the received instruction; when the received instruction from the remote control is a Chinese or English selection instruction sent by an arrow button of the remote control, performing Step (b4); when the received instruction from the remote control is a letter input confirmation instruction sent by the Ok button of the remote control, performing Step (b5); when the received instruction from the remote control is a return instruction sent by an arrow button of the remote control, performing Step (b6);
(b4) moving the cursor to a target Chinese or English character, and performing Step (c);
(b5) inputting the target letter to a pre-selection box, and performing Step b1; and
(b6) returning to a state of the previous step.

18. The non-transitory computer-readable medium according to claim 17, wherein after Step (b5) and before performing Step (b1), the method further comprises:
(b7) according to the target letter input into the pre-selection box, rearranging letter characters on the soft keyboard according to an association function rule.

19. The non-transitory computer-readable medium according to claim 18, wherein when the target soft keyboard displays a plurality of preset pinyin characters that are arranged one by one, and after re-performing Step (b1), the method further comprises:
(b8) determining whether the target letter at the current cursor and the letter character input earlier into the pre-selection box are able to form a pinyin; if yes, performing Step (b2); otherwise, performing Step (b9); and
(b9) according to a preset phrase input mapping table, displaying a candidate Chinese phrase table corresponding to a phrase formed by the target letter at the current cursor and the letter character input earlier into the pre-selection box, and performing Step (b3).

20. The non-transitory computer-readable medium according to claim 13, wherein the method further comprises:
(d1) in response to a position switch instruction sent by the Left and Right buttons on the remote control, switching the cursor to the input box or the soft keyboard; and
(d2) when the cursor is in the input box, in response to a delete character instruction sent by the Down button on the remote control, deleting a character already input into the input box.
